(19) United States
(12) Patent Application Publication
(10) Pub. No.: US 2011/0138437 A1
(43) Pub. Date: Jun. 9, 2011

(54) METHOD AND SYSTEM FOR PROVIDING BOTH LIVE VIEWING AND VIDEO ON DEMAND

(76) Inventors: Shivakumar Mahadevappa, Sunnyvale, CA (US); Siddhartha Annapureddy, Palo Alto, CA (US); Thomas Jansen, San Francisco, CA (US)

(21) Appl. No.: 12/632,724

(22) Filed: Dec. 7, 2009

(51) Int. Cl. H04N 7/16

(52) U.S. Cl. 725/135

(57) ABSTRACT

A method in which user generated video content is distributed over a peer to peer network as live broadcast but may be viewed at any point using 2 overlayed peer networks. Video is rendered during download and a user may request a specific point in the video content and that point and all subsequent video content will be downloaded and rendered first via a peer to peer network.

### CLAIM FOR PRIORITY

This application claims priority to U.S. nonprovisional application No. 12/604,400 submitted on Oct. 23, 2009, invented by Siddhartha Annapureddy et al.

### FIELD OF THE INVENTION

The present invention generally relates to the sharing and distribution of video content over an electronic information network. The present invention more specifically relates to a process in which users may access live video data and/or audio data feeds late and view the data stream from the beginning using peer to peer technology.

### BACKGROUND OF THE INVENTION

Presently, there is a substantial Internet culture of on-line sharing of video content. The method in which this is done is often through peer-to-peer (P2P) networks. P2P networks are computer networks that provide an alternative to central server distribution methods. P2P networks and may be operated at a reduced cost burden to a service provider to the extent that data storage is facilitated by network members rather than a central server operated by the service provider.

P2P file transfer often works by dividing a large video data program into a plurality or multiplicity of parts. For example, one file may have 100 parts. While trying to view that file, a user would connect to one or more peers, for example, 5 peers, A, B, C, D, and E all become connected to the original user. Those peers begin sending the user seemingly random pieces that they possess, so could potentially transfer A piece 25, while B concurrently transfers piece 12, C sends 98, D sends 57, and E sends 2. Once a piece finishes loading, that peer will begin to send the user another piece until all 100 pieces are there. Further, such content transfers are often managed by torrent files which assemble the pieces together; these files are often made available by various web entities such as mininova, pirate bay, or isohunt, then the download is managed by a 3^{rd} party client program such as Bittorrent or Utorrent.

A core issue with this process is that this process lacks an inclusive method with which to view the shared video content live during a download as streamed content, further the process lacks an option to choose which pieces of a file are downloaded. Additionally, removing the need for 3^{rd} party client software would be an advantage to a user.

Traditional video on demand (hereinafter, “VOD”) systems, like Youtube, are client-server systems, which use the VOD service providers' CPU, storage, uplink bandwidth, and require the broadcaster to upload content and provide the license guarantee to the service provider. This has the following consequences: the VOD service provider has the open-ended cost of CPU, storage and uplink bandwidth, and the VOD provider is liable to license infringement lawsuits, since they cannot get the broadcaster to validate each VOD broadcast.

### SUMMARY OF THE INVENTION

A first example of the presently invented method involves a first seeder who broadcasts live video content to be shared with other peers who join the live session. The seeder acts as a tracker. These peers may in turn transfer the video content to other peers when requested from the tracker. If a peer is to join the live broadcast late or a peer wishes to pause or “rewind” the broadcast, the presently invented method allows for this functionality.

By overlaying 2 peer networks over each other, a live broadcast network and a VOD network, users may actively switch between one network to the other in order to view either live video or audio data or past data. Members of one network would also be members of the second network. A peer of the networks who joins a live broadcast network late may be transferred to a VOD network in order to view a broadcast in its entirety.

### INCORPORATION BY REFERENCE

All publications mentioned herein are incorporated herein by reference to disclose and describe the methods and/or materials in connection with which the publications are cited. All publications, patents, and patent applications mentioned in this specification are herein incorporated by reference in their entirety and for all purposes to the same extent as if each individual publication, patent, or patent application was specifically and individually indicated to be incorporated by reference.

Such incorporations include U.S. Pat. No. 6,711,622 (Inventors: Michael J. Fuller et al; Issued on Mar 23, 2004) titled, “Video and audio streaming for multiple users”; U.S. Pat. No. 7047406 (Inventors: Jorg Gregor Schleicher et al; issued on May 16, 2006) titled, “Method and system for providing a secure peer-to-peer file delivery network; U.S. Pat. No. 6892210 (Inventors: Jason Erickson et al; Issued on May 10, 2005) titled “Database management and synchronization across a peer-to-peer network”; U.S. patent application Ser. No. 11/384,238 (Inventor: Craig Howard Seidel; Filed on Mar. 17, 2006) titled “Peer-to-peer gateway”; U.S. patent application Ser. No. 11/519,990 (Inventors: Andrew Hickmott et al; Filed on Sep. 12, 2006) titled “Security techniques for cooperative file distribution”; U.S. patent application Ser. No. 12/112,980, titled “Formatting Information for Transmission over a Communication Network”; U.S. patent application Ser. No. 12/112,759, titled “Sharing of Information over a Communication Network”; and PCT Application No. PCT/US2008/061921 (Inventors: Anne Aaron et al; Filed Apr. 29, 2008) titled “Sharing of Information and Formatting Information for Transmission over a Communication Network”.

The publications discussed or mentioned herein are provided solely for their disclosure prior to the filing date of the present application. Nothing herein is to be construed as an admission that the present invention is not entitled to antedate such publication by virtue of prior invention. Furthermore, the dates of publication provided herein may differ from the actual publication dates which may need to be independently confirmed.

### BRIEF DESCRIPTION OF THE DRAWINGS

These, and further features of the invention, may be better understood with reference to the accompanying specification and drawings depicting the example, in which:

FIG. 1 is a block diagram of a double peer-to-peer (P2P) network;

FIG. 2 is a block diagram of the data composition of video content;

FIG. 3 is a block diagram of an exemplary peer system;

FIG. 4 is a block diagram of an exemplary video server;

FIG. 5 is a block diagram of an exemplary user interface for video on demand;

FIG. 6 is a flow chart of data flow in an exemplary method of sharing video content with a double P2P network; and

FIG. 7 is a flow chart of an exemplary method of authenticating.

### DETAILED DESCRIPTION

In describing aspects of the invention, certain terminology will be utilized for the sake of clarity. Such terminology is intended to encompass the recited example, as well as all technical equivalents, which operate in a similar manner for a similar purpose to achieve a similar result.

It is to be understood that this invention is not limited to particular aspects of the present invention described, as such may, of course, vary. It is also to be understood that the terminology used herein is for the purpose of describing particular aspects only, and is not intended to be limiting, since the scope of the present invention will be limited only by the appended claims.

Methods recited herein may be carried out in any order of the recited events which is logically possible, as well as the recited order of events.

Where a range of values is provided herein, it is understood that each intervening value, to the tenth of the unit of the lower limit unless the context clearly dictates otherwise, between the upper and lower limit of that range and any other stated or intervening value in that stated range, is encompassed within the invention. The upper and lower limits of these smaller ranges may independently be included in the smaller ranges and are also encompassed within the invention, subject to any specifically excluded limit in the stated range. Where the stated range includes one or both of the limits, ranges excluding either or both of those included limits are also included in the invention.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, the methods and materials are now described.

It must be noted that as used herein and in the appended claims, the singular forms “a”, “an”, and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

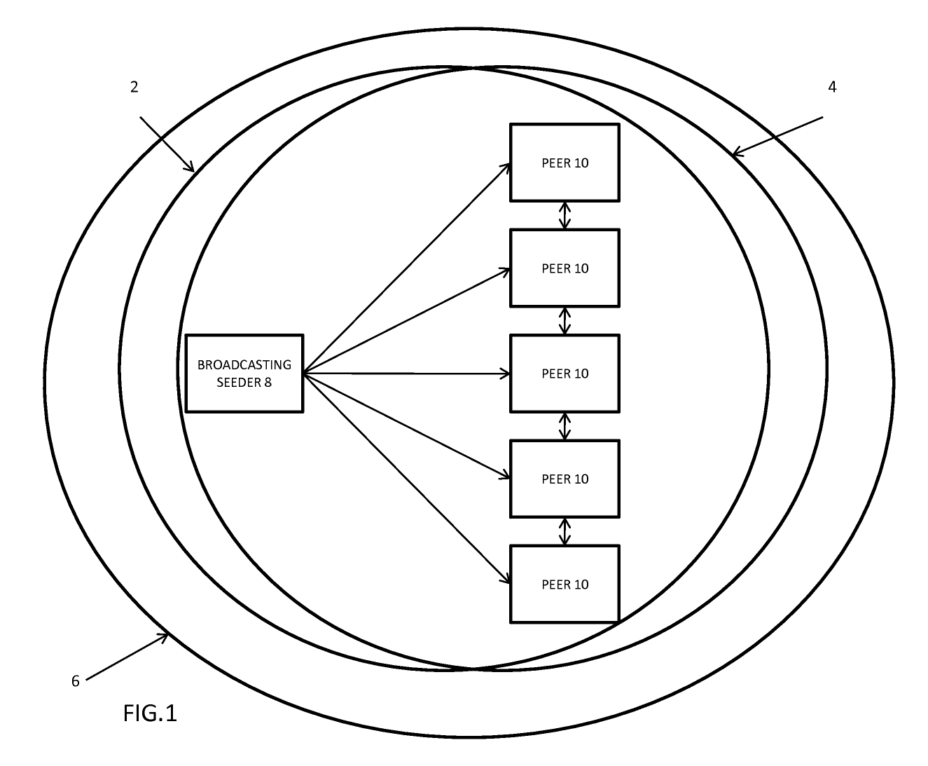

Referring to FIG. 1, FIG. 1 is a block diagram of a double P2P network. The present invention involves two networks, a live broadcast network 2 and a video on demand (hereafter: VOD) network 4. Both of these networks 2, 4 are accessed via a mass data network such as the internet 6. These networks 2, 4 are populated by a data source 8 and with additional peers 10. The data source 8 would posses some form of multimedia data, such as video content in which to share across these peer networks 2, 4 and could serve as a tracker for the data sharing process. Alternatively to the data source 8 serving as a tracker, a distributed hash table (hereafter: DHT) could be used to maintain an index of network members 8, 10. Members of the networks 2, 4 are the same, that is to say that the data source 8 for the live broadcast network 2 is the same data source in the VOD network 4, and that all the peers 10 are shared from the live network 2 to the VOD network 4. As the networks 2, 4 are overlayed on each other switching from receiving data from the live network 2 to the VOD network 4 and visa-versa can be done seamlessly. As both networks 2, 4 are peer networks in which all members 8, 10 of the networks 2, 4 may be connected to each other, once the data source 8 has propagated multimedia data through to the peers 10, the peers 10 continue to share that same data with still more peers 10. The connection between members of the network 8, 10 can be facilitated by a client software or any other suitable method known in the art.

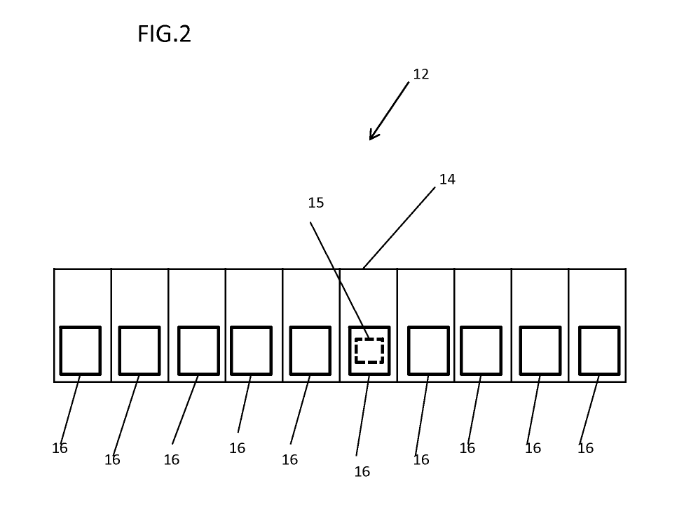

Referring to FIG. 2, FIG. 2 is a block diagram of the data composition of video content 12. Video content 12 when arranged as data consists of multiple segments 14. Each of these segments 14 comprises a given length of video, for example 30 seconds. Each segment 14 contains data packets 16 which may be interpreted by a computer as video. The number of packets per second of video can vary greatly depending on temporal resolution of video content 12, however assume for the sole purpose of subsequent examples that there are about seventy-five packets 16 per second of video data 12. The variance of resolution can be different from one of the parallel networks 2, 4 to the other even though the video content 12 appears to be the same. Another way to view a breakdown of the video data 12 is as a data block 15. A data block 15 could be as small as a one of the packets 16 and as large as a segment 14. The denomination of a data block 15 would be used by a tracker in denoting which members 8, 10 of the P2P network 2, 4 had what portions of the video data 12.

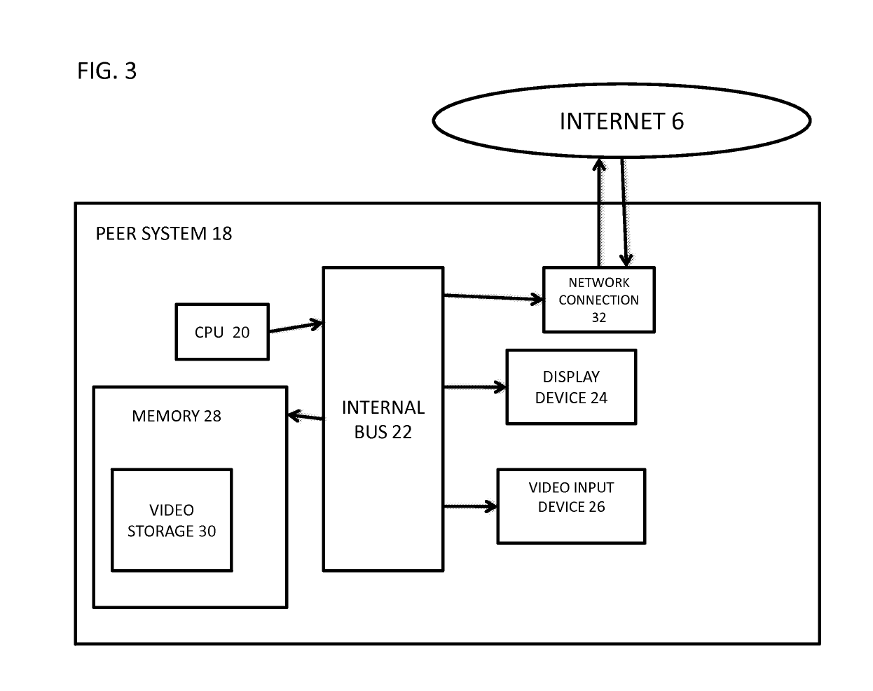

Referring to FIG. 3, FIG. 3 is a block diagram of an exemplary peer system 18. A peer system 18 would be used by a peer 10 of the two networks 2, 4 in order to access and accept data 12 from a data source 8 and would include any or all of the following components. A peer system 18 would include a CPU 20, connected to an internal BUS 22, which would have some form of display device 24, a video input device 26, a memory 28 in which a video archive 30 could be saved, and some form of network adapter 32 for connecting to a mass network 6 such as the internet. An example of an acceptable peer system 18 would be the Alienware M17x laptop as marketed by the Dell corporation; a Macbook pro as marketed by Apple Computer Inc.; an internet enabled desktop computer; a system enabled to have the possibility of running the computer game, “World of Warcraft” as produced and marketed by Blizzard Entertainment; a network enabled mobile device such as an Apple iPhone; and any other suitable device known in the art.

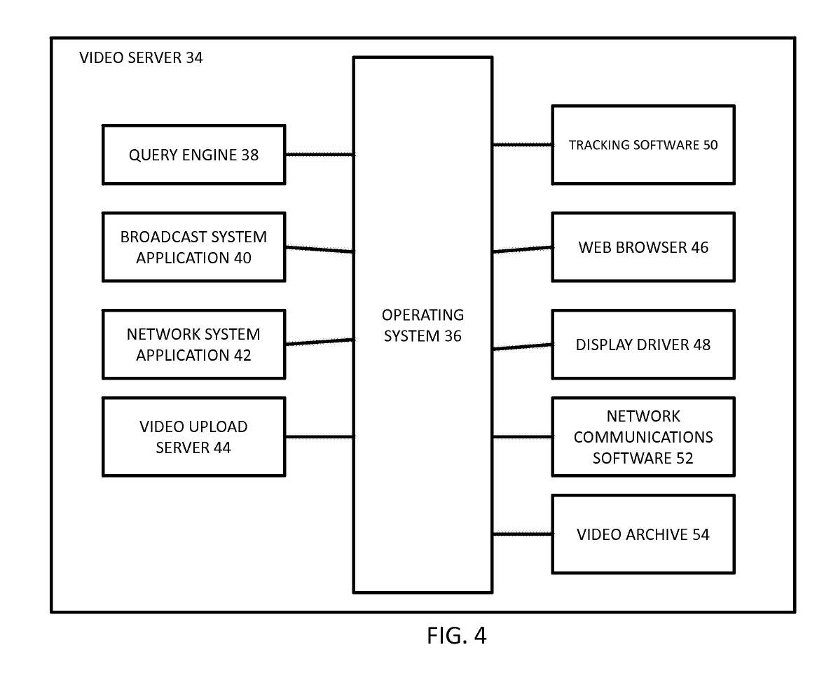

Referring to FIG. 4, FIG. 4 is a block diagram of an exemplary video server 34. A video server 34 could be used by a data source 8, though in certain configurations a peer system 18 of FIG. 3 could be used by a data source 8. A video server's 34 software components would include any or all of the following components; an operating system 36, which would allow the operation of: a query engine 38 for facilitating the operation of the video server 34, a broadcast system application 40 to facilitate connections with peer systems 18, a network system application 42 to support a network, a video upload server 44 in order to receive video content 12, a web browser 46, display drivers 48, tracking software 50, and network communications software 52. In certain variations on the invented method video archive software 54 would also be included.

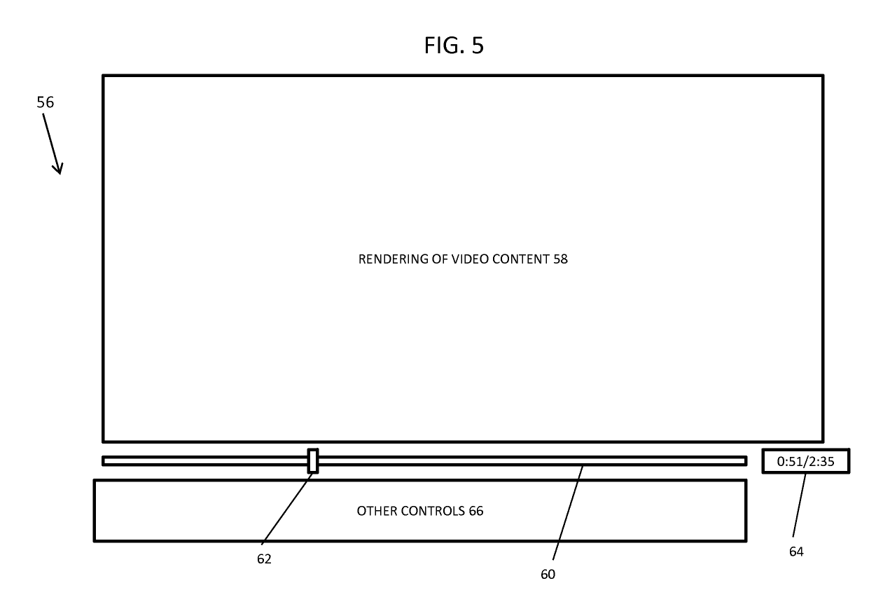

Referring now generally to FIGS. 1-4 and more specifically to FIG. 5, FIG. 5 is a block diagram of an exemplary user interface 56 for video broadcasts. In a first exemplary method of present invention a data source 10 would make known the ownership of video data 12. The data source 8 will then allow this video to be searchable in a standard query web engine 38. Alternatively, in a second exemplary method of present invention a client software could be used to search through archives of video content made available by a plurality of data sources 8. A requesting peer 10 can then search for a video data 12 that a source 8 has made available, and once the video data 12 is selected, the requesting peer 8 is transferred to a user interface 56 as shown in FIG. 5. Optionally the data source 8 may also be viewing this user interface 56, and have the video data 12 rendered concurrently with other peers 10. The requesting peer 10, begins receiving the shared video data 12, starting from the first data block 15 and proceeding chronologically from the data source 8, and any other connected peers 10 as long as they possess relevant data blocks 15 of the video data 12. The user interface 56 renders the video data 12 in a screen 58, and the progress of the rendering is shown via a progress bar 60 and a progress cursor 62 that indicates to the peer 10 how far through the video data 12 rendering currently is and how much still remains. This can optionally also be shown in a digital format 64. The progress cursor 62 may be altered by a user of the peer system 10 in order to adjust which data block 15 the peer 10 wishes to have rendered. For example, if the progress cursor 62 were to be dragged from the beginning of the progress bar to a third of the way through, a data block 15 from roughly a third of the way into the video data 12 followed by subsequent data blocks 15 would be requested and downloaded rather than receiving from the connected network members 8, 10 data blocks 15 from the beginning of the video data 12. Optionally other controls 66 could be incorporated into the user interface 56; these could include but are not limited to volume controls, quality controls, full screen controls, or add to a favorite list control.

The user interface 56 flows seamlessly between the networks 2, 4 depending on usage. For a peer 10 who connects to a data source 8, as the source 8 begins to broadcast multimedia data or video content 12 the live network 2 is used in order to transfer data. For a peer 10 who connects to a data source 8 after the beginning of a live broadcast, or a peer 10 who connected promptly but wishes to render different data blocks 15 than the live broadcast would instead uses the VOD network 4 in order to receive data.

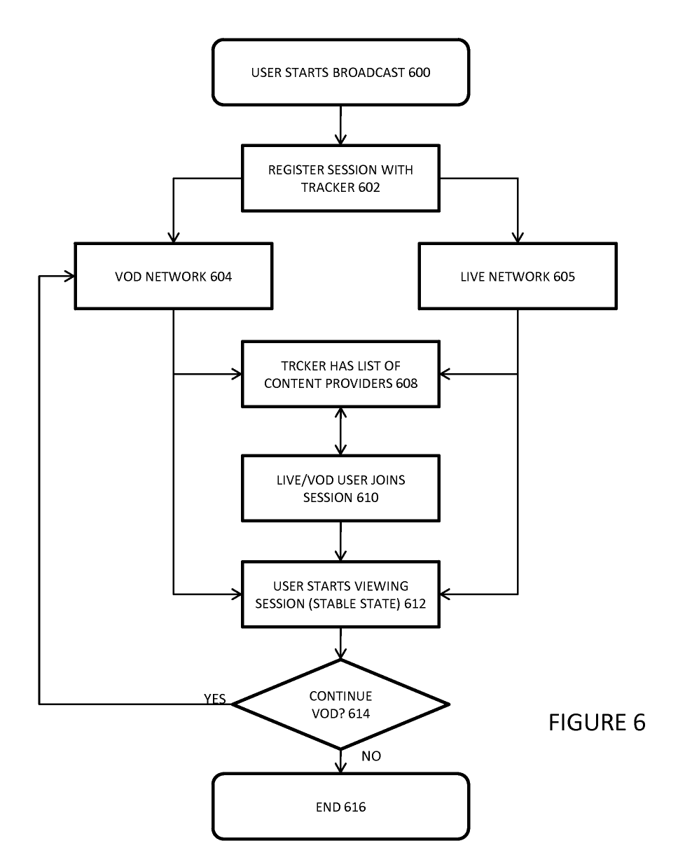

Referring now to FIG. 6, FIG. 6 is a flow chart of data flow in an exemplary method of sharing video content via double networks. The process begins with a data source 4 beginning broadcast of vide data 12 or some other multimedia data (600). The broadcast session is then registered with a tracker, often the source itself 8 (602). Two networks 2, 4 are established in which data may flow from a source 8 to peers 10 and then subsequently from one peer 10 to another peer 10, in step 604 a VOD network 4 is established and in step 606 a live network 2 is established. The tracker maintains a persistent list of content providers 8 and other members 10 of these networks 2, 4 (608). In step 610, as peers 10 connect to the session the tracker updates the list of members 8, 10. In step 612, which chronologically may begin as early as the networks 2, 4 are established; the source 8 begins a live broadcast of video data 12. Throughout step 612 additional peers 10 may be connecting to the session and may receive video data 12 from the peer network 2, 4 which makes the most sense for that particular peer's 10 needs. When the live broadcast ends, moving the process to step 614, there is no longer a use for the live network 2, however the VOD network 4 may continue to run as long as the source 8 or peers 10 who possess the video content 12 continue to stay connected to the session. When all peers 10 and the source 8 disconnect, the session ends (616).

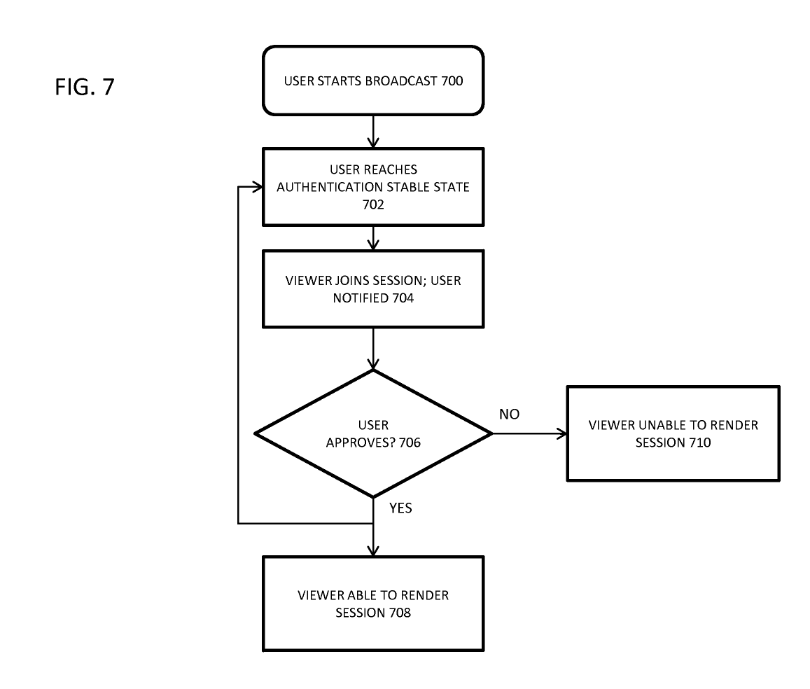

Referring now to FIG. 7, FIG. 7 is a flow chart of an exemplary method of authenticating. Optionally the invented method displayed in FIG. 6 may include additional steps. As before with FIG. 6, a source 8 begins broadcast of video data 12 (700). The source 8 stays idle until a peer 10 attempts to join the video session (702). The peer 10 transmits an authentication key to the source 8 with a request to join a video session supported by the source 8, whereupon the source 8 is provided with the authentication key and is notified of the request by the peer 10 to join the video session (704). The source 8 attempts to validate the authentication key as transmitted by the peer 10 in step 706 and determines whether to allow this particular peer 10 into the video session. If authenticated and allowed by the source 8, the peer 10 begins to download and render the video data 12 in step 708. The source 8 returns to step 702 to upload video data and wait for additional peers 10. If the source 8 does not allow that particular requesting peer 10 to join the session, the particular peer 10 will not be able to download and render the video data 12 (710). Various common methods could be used in order to achieve a proper authentication key like client assigned temporary or permanent passwords, PKI certificates, digital signatures, secure shell (SSH), a list of allowed IP addresses, creation of user accounts followed by account information checks, or any other suitable means known in the art.

The foregoing disclosures and statements are illustrative only of the Present Invention, and are not intended to limit or define the scope of the Present Invention. The above description is intended to be illustrative, and not restrictive. Although the examples given include many specificities, they are intended as illustrative of only certain possible examples of the Present Invention. The examples given should only be interpreted as illustrations of some of the examples of the Present Invention, and the full scope of the Present Invention should be determined by the appended claims and their legal equivalents. Those skilled in the art will appreciate that various adaptations and modifications of the just-described examples can be configured without departing from the scope and spirit of the Present Invention. Therefore, it is to be understood that the Present Invention may be practiced other than as specifically described herein. The scope of the present invention as disclosed and claimed should, therefore, be determined with reference to the knowledge of one skilled in the art and in light of the disclosures presented above.

1. A method for providing access to video data in an electronics communications network, the method comprising:
a. Accepting a video data stream from a broadcast system;
b. Storing the video data at a storage system; and
c. Enabling a requesting system to access either the video stream as transmitted from the broadcast system or the video data from the storage system.

2. The method of claim 1, wherein the video data stream is delivered to the requesting system.

3. The method of claim 2, wherein the requesting stream requests access to the video data of the storage system.

4. The method of claim 1, wherein the video data is provided from the storage system to the requesting system.

5. The method of claim 4, wherein the requesting stream requests access to the video data stream.

6. The method of claim 1, wherein the broadcast system, the storage system and the requesting system are comprised within a peer-to-peer network of the electronics communications network.

7. The method of claim 1, further comprising enabling the requesting system to specify a preferred element of the video data from which to initiate access to the video data.

8. The method of claim 7, further comprising:
a. Receiving a plurality of video data preferred element access requests from a plurality of requesting systems;
b. Determining at least one preferred element of the video data that for which a high incidence of requests are received; and
c. Distributing storage of the at least one preferred element among a plurality of storage systems.

9. The method of claim 1, wherein the broadcast system directs the electronics communications network to distributing storage of the at least one preferred element among a plurality of storage systems

10. The method of claim 1, further comprising rendering a first video data element by the requesting system, and enabling the requesting system to demand access to a second video data element, wherein the second video data element is sequentially ordered prior to the first video data element.

11. The method of claim 10, wherein the first video data element is received by the requesting system from the broadcast system.

12. The method of claim 10, wherein the first video data element is received by the requesting system from the storage system.

13. The method of claim 1, wherein the requesting system distributes video data to at least one client system within the electronics communications network.

14. The method of claim 13, wherein the requesting system distributes video data to a plurality of client system within the electronics communications network.

15. The method of claim 13, wherein the storage system distributes video data to a plurality of client system within the electronics communications network.

16. The method of claim 1, further comprising uploading of the video data to a video-on-demand server after the broadcast system ceases the transmitting the video data stream.

17. The method of claim 16, further comprising providing the video data from the video-on-demand server to the requesting system.

18. The method of claim 16, further comprising providing the video data from the video-on-demand server to the storage system.

19. A method comprising:
a. Establishing a peer to peer network (“P2P network”) within an electronics communications network;
b. Receiving by the P2P network of a live data stream;
c. Enabling access by each member of the P2P network of the live data stream; and
d. Enabling access to previously received elements of the data stream to each member of the P2P network.

20. A method comprising:
a. Establishing a peer to peer network (“P2P network”) within an electronics communications network;
b. Requiring each member of the P2P network to provide a memory resource to the P2P network, whereby the financial burden of maintaining each memory resource is distributed;
c. Enabling access by each member of the P2P network to a data stream; and
d. Enabling access to previously received elements of the data stream to each member of the P2P network.
